(19) United States
(12) Patent Application Publication
(10) Pub. No.: US 2005/0164118 A1
(43) Pub. Date: Jul. 28, 2005

(54) Method of joining a workpiece and a microstructure light exposure

(76) Inventors: Claus Barholm -Hansen, Vaerlose (DK); Jacques Jonsmann, Gorlose (DK)

Correspondence Address: FOLEY HOAG, LLP;PATENT GROUP, WORLD TRADE CENTER WEST, 155 SEAPORT BLVD, BOSTON, MA, 02110, US

(21) Appl. No.: 10/503,161

(22) PCT Filed: Jan. 31, 2003
(86) PCT No.: PCT/DK03/00062

(30) Foreign Application Priority Data
Jan. 31, 2002 (DK) PA 2002 00157

(51) Int. Cl. G03C 1/76

(52) U.S. Cl. 430/270.1

(57) ABSTRACT

A method of joining a workpiece and a microstructure by light exposure, a microstructure obtainable by the method comprising a workpiece joined thereto, means thereto and use thereof; in particular a microstructure-forming composition comprising a light-sensitive, structure-forming material comprising one or more photo resist materials which are sensitive to preferably UV-light, and a light-absorbing material comprising one or more light-absorbing substances absorbing preferably IR light and being in an amount sufficient to produce heat upon exposure to said absorbed light; a microstructure-forming preparation comprising such composition; a method of producing a microstructure on a substrate; and a microstructure obtainable by the method; a method of joining a workpiece and a microstructure, a microstructure obtainable by the method comprising a workpiece joined thereto, e.g. for producing closed micro flow channels in a micro flow system; and use of such a microstructure, e.g. in lab-on-chip applications, in point-of-care systems, in high-through-put screening systems, preferably in systems for screening active compounds in fluids, in particular biological fluids.

### 1. BACKGROUND OF THE INVENTION

The present invention relates to a method of joining a workpiece and a microstructure by light exposure, a microstructure obtainable by the method comprising a workpiece joined thereto, means thereto and use thereof; in particular a microstructure-forming composition; a microstructure-forming preparation comprising such composition; a method of producing a microstructure on a substrate; a microstructure obtainable by the method; a method of joining a workpiece and a microstructure, a microstructure obtainable by the method comprising a workpiece joined thereto, e.g. for producing closed micro flow channels in a micro flow system; and use of such a microstructure, e.g. in lab-on-chip applications, in point-of care systems, in high-through-put screening systems, preferably in systems for screening active compounds in fluids, in particular biological fluids.

1. The Technical Field

In micro system technology, e.g. lab-on-a-chip or biochips, sealing of the micro system in order to provide a micro structure comprising integral channel structures such as flow channels is a challenge. Most chips are made by joining two parts, i.e. joining a microstructured first part and an unstructured second part, e.g. a cover or a “lid”. In case that both the first and the second parts contain structures, aligning between the two parts is required. Access to the micro channels are typically be made through holes or vias in the structured part.

In the case where both parts contain structures and thus requires aligning, there is a risk of misalignment which results in channels of varying cross-sections. These variations can be significant e.g. with very small capillary cross-sections.

Silicon-based micro systems apply sealing by anodic bonding and heating. Polymer-based micro systems apply welding or lamination methods.

When the actual method of joining is considered some traditional methods for joining polymer materials are obviously not applicable. Friction-stirring welding or other methods that rely on frictional heating will obviously have a problem with geometrical stability.

Pre-structured parts of micro channel systems typically comprise micro channel widths in the range 1 μm to 1 mm, for which it is difficult to avoid geometrical changes. Such geometrical changes can arise from the joining mechanism which often involves applying heat to induce a joining of the parts. Further, the softened parts can easily be deformed because it is necessary to apply a moderate compression pressure to establish an intimate contact between the two parts while they are heated, and subsequently cooled.

Generally, polymer parts contain stresses from the manufacturing process. A subsequent heating results in unwanted geometrical changes (i.e. warping). Even in the absence of pre-bonding stress in the parts to be joined, there is a risk that thermal contraction results in stress/geometrical changes when heating the entire structure after the joining process.

Another disadvantage of heating the entire joined microstructure assembly is that temperature sensitive chemicals or organisms, contained in the channels or cavities, could be adversely affected.

Joining techniques based on gluing and adhesion also have problems associated with their use. The material properties of the glue or the adhesive may not be comparable to those of the bulk material, if the intended use of the joined structure involves aggressive chemicals.

Further, in uses where the zeta-potential of the channel walls is used to define an electro osmotic flow, it is undesirable to have a second material such as glue or an adhesive present. Simply applying the glue will also give rise to an issue of edge definition and how the glue should be applied in order not to flow into the structures effectively changing the channel cross section.

Consequently, there is a need for an improved method of joining a workpiece and a microstructure.

2. Prior Art Disclosures

WO 96/20 429 discloses a method and means of forming a lithographic film with a positive working photosensitive composition, the method comprising coating a UV-photo-sensitive and thermal-sensitive composition on a substrate, exposing said coating to ultraviolet radiation to make it developable, and digitally imaging by means of a laser emitting in the infra-red region, and developing the plate to remove those areas not exposed to the laser.

EP-B1-0 997 261 discloses a laser joining method of joining together different workpieces made of plastic, or joining plastics to other materials; the method comprising selecting a first and a second workpiece, said first workpiece being transparent for a laser beam, and said second workpiece being made of a material that is absorbent for said laser beam; contacting surfaces of said two workpieces to be joined; irradiating said laser beam through said first workpiece onto said second workpiece so as to melt adjacent contact surfaces of said first and second workpieces; and subsequent cooling thereof under pressure.

WO 00/20 157 discloses a method of forming a weld between two workpieces over a joint region, the method comprising exposing the joint region to incident radiation, said radiation having a wavelength outside the visible region so as to cause melting of the surface of one or both workpieces at the joint region, and allowing the melted material to cool.

U.S. Pat. No. 5,773,170 discloses an image forming element comprising an image-forming medium comprising an UV-blue sensitive compound and a dye absorbing at a longer wavelength bleaching absorption of said UV-blue sensitive compound.

U.S. Pat. No. 6,195,264 discloses a cavity-type chip module comprising a laminate layer with an aperture defined therein and a corresponding stiffener, said laminate layer and stiffener being joined together with an adhesive joining layer interposed there between at either of said laminate layer or said stiffener, and using a lamination technique such as vacuum lamination or hot roll lamination at a suitable temperature and pressure. Preferably said joining layer comprises an epoxy-based photo imageable, dry film dielectric material having a window developed therein, said window being aligned with said aperture.

### 2. DISCLOSURE OF THE INVENTION

Object of the Invention

It is an object of the present invention to seek to provide an improved method and means of producing a microstructure, in particular a microstructure with a joined workpiece.

It is another object of the present invention to seek to provide an improved method and means of joining a workpiece to a microstructure.

It is still another object of the present invention to seek to provide an improved microstructure, in particular an improved micro flow structure.

Further objects appear elsewhere in the description.

Solution According to the Invention

These objects are fulfilled by various aspects of the invention.

Microstructure-Forming Composition

In an aspect, the present invention fulfils these objects by providing a microstructure-forming composition, the composition comprising:
(i) a light-sensitive, structure-forming material, said material comprising one or more photo resist materials which are sensitive to light of one or more first wavelengths; said photo resist materials being structurable by exposure to light of said one or more first wavelengths, and a subsequent chemical development, and
(ii) a light-absorbing material, said material comprising one or more light-absorbing substances absorbing light at one or more second wavelengths, said one or more second wavelengths being different from said one or more first wavelengths of said photo resist materials, and said one or more light-absorbing substances being in an amount sufficient to produce heat upon exposure to said one or more second wavelengths,
whereby it is obtained that a microstructure can be provided on a substrate using said microstructure-forming composition, e.g. by photo-lithographic methods on photo resist materials, and it is obtained that a workpiece can be joined to said microstructure on said substrate, e.g. providing a closed cavity or closed flow channel therein using mask-welding and using a light of said one or more second wavelengths which is transmitted through said workpiece, or which is transmitted through the substrate.

In case the transparent workpiece melts or softens at a sufficiently lower temperature than the microstructure containing the light-absorbing material, the workpiece and the structure can be joined without using a mask whereby the structural integrity is maintained in the microstructure.

A large advantage of transmission welding is that only the interface will be heated. This ensures good geometrical stability as polymers have notoriously large coefficients of thermal expansion.

Stresses resulting from the joining of materials with very disparate thermal expansion coefficients can also be minimized as the bulk of the materials remain virtually unheated.

Practically the photo-structured material will be residing on substrates that allow for the necessary photolithography steps to be carried out. When this is the case, it is important to observe that when the interface between the lid and the photo structured material is heated it should be avoided to heat the interface between the substrate and the photo structured material. This can partly be avoided when the dye is strongly absorbing so that little or no radiation reaches deeper into the material, or when the thickness of the material is sufficiently large. The heating of the substrate could lead to delamination due to large differences in thermal expansion coefficients.

“Light-Sensitive, Structure-Forming Material”

Generally, said one or more photo resist materials which are sensitive to light of one or more first wavelengths are structurable by exposure to light of said one or more first wavelengths, followed by a subsequent chemical development.

Such photo resist materials are known in the art,.

In a preferred embodiment, said one or more photo resists materials are sensitive to UV light at said one or more first wavelengths.

It is preferred that said light of said one or more first wavelengths has a wavelength the range 190 to 450 nm, preferably 300 to 400 nm, whereby high power light sources such as UV mercury lamps can be used.

Other wavelengths might be applied depending on the light-sensitivity properties of the structure-forming material, and absence of significant interference with the light-absorbing material.

Generally, the photo resist materials comprise any material suitable of forming said structure upon exposure to said light, and development thereof.

In a preferred embodiment, said one or more photo resist materials comprise a phenoxy polyol resin formed as the condensation product of epichlorohydrin and a bisphenol A, preferably an epoxidized multifunctional bisphenol A formaldehyde novolac resin, in particular an octafunctional bisphenol such as e.g. EPON SU 8™, supplied e.g. by MicroChem, Inc.

The light-sensitivity of the structure-forming material can originate from one or more of its components or from a mixture thereof.

In a preferred embodiment, said light-sensitivity and structure-forming material further comprising a photo initiator, preferably a cationic photo initiator, in particular a triarylsulfonium hexafluoroantimonate palt. The photo initiator is typically included in the commercial product SU-8™.

Specifically, it is preferred that said one or more photo resist materials upon exposure to said light of one or more first wavelengths are developed as a positive photo resist, a negative photo resist, or a combination thereof.

“Light-Absorbing Material”

The light-absorbing substances can be any light-absorbing substance that is compatible with said light-sensitive and structure-forming material, and which can absorb light at said one or more second wavelengths and produce heat.

Generally, said light-absorbing material comprises one or more light-absorbing substances absorbing light at one or more second wavelengths, said one or more second wavelengths being different from said one or more first wavelengths of said photo resist materials, and said one or more light-absorbing substances being in an amount sufficient to produce heat upon exposure to said one or more second wavelengths.

In a preferred embodiment, said one or more light-absorbing substances is an IR absorbing material, or a mixture of IR absorbing materials, whereby light can be selected to absorb in a IR region of the electromagnetic spectrum which does not interfere with the light-sensitivity of the structure-forming material, which preferably is predominantly sensitive in the UV region.

Also, IR irradiation may be selected so that it does not interfere or cause damage to substrates and/or damage to microstructures on such substrates.

Preferably said light of said one or more second wavelengths have a wavelength in the range of 700 nm to 15 μm, preferably of 780 to 1700 nm, most preferably of 800 to 1000 nm.

Generally, the amount of said one or more light-absorbing substances in said light-absorbing materials is selected so that following formation of a structure sufficient heat can be produced locally in or near a surface of said structure.

If too much light-absorbing material is present, its presence might influence the structure-forming properties of the composition, e.g. directly influencing the mechanical structuring properties and/or influencing the UV absorbing properties thereof.

More detailed the invention, in a preferred embodiment, combines a UV photosensitive material (such as Microchem EPON SU-8 or a dry photoresist-film), with an admixed IR-absorbing dye, i.e. the commercial dyes from Epolin: Epolight 2057 of from Gentex Corp. in the filtron series. The amount of dye is chosen so it does not interfere significantly with the lithographic properties of the photosensitive material. The material can i.e. be structured as known in the art, using UV light and an appropriate developer [see M. Madou, “Fundamentals of Microfabrication”, CRC Press (1997), or similar monograph].

The IR sensitive dye allows the structured material to be heated by absorbing the light directed at the material. Sources of IR light include incandescent lamps and diode lasers. When the structured material is pressed together with a second material (a lid) that is transparent to IR radiation, the interface between the two materials can be heated sufficiently for the two materials to be joined permanently depending on the detailed properties of the materials. This process is referred to as transmission welding.

For some applications, the structured material is transparent to the IR radiation and the IR radiation is applied there through.

In a preferred embodiment, said one or more light-absorbing substances are present in an effective amount to absorb light energy for producing a predetermined amount of heat whereby heat for softening a joining surface of a workpiece can be obtained.

It is with the skills of a person in the art to experimentally optimise the concentration of said one or more light-absorbing substances to provide said predetermined amount of heat for adhesion of the workpiece to the microstructure on the substrate.

Generally, the required heat for providing a sufficient softening and/or melting of the surface of the workpiece to affect adhesion is obtained by simple calibration of the amount of said one or more light-absorbing substances. For a given heat-generating light source, preferably an IR-light source, and said one or more light-absorbing substances, preferably one or more IR-absorbing dyes, the quality of the adhesion of the joined workpiece to the microstructure on the substrate, e.g. expressed in terms of bonding stress, and resistance to mechanical stress of the joined pieces, is calibrated against exposures to the heat-generating light, e.g. in terms of exposure time and irradiance, and optional mechanical compression conditions for the joining process, at various concentrations of said one or more light-absorbing substances. The optimal concentration or range of concentrations under the prevailing exposure and joining conditions can then be selected.

In a preferred embodiment, said one or more light-absorbing substances are selected from the groups comprising: cyanine, squarylium and croconium dyes, said substances being commercially available dyes, and such as Epolight™ 2057 supplied by Epolin and the dyes in the Filtron series supplied by Gentex Corp.

Microstructure-Forming Preparation

Depending on its application, the microstructure-forming composition is formulated in a suitable preparation.

In another aspect, the present invention fulfils these objects by providing a microstructure-forming preparation, the preparation comprising a composition according to the invention, said preparation being in form of a liquid, a paste, a film, or a laminate.

In such a preparation, e.g. in form of a film or a laminate, the light-absorbing substances is localised at suitable locations therein where the production of heat is required.

In a preferred embodiment, the preparation comprises an exposed surface wherein said one or more light-absorbing substances are in an amount sufficient to produce heat at said exposed surface upon exposure to light of said one or more second wavelengths, preferably a major portion of said amount of said one or more of light-absorbing substances being present in or near said exposed surface.

In a particular preferred embodiment, the preparation is in form of a laminate wherein said one or more light-absorbing substances are present in a top layer of said laminate.

Method of Producing a Microstructure

In another aspect, the present invention fulfils these objects by providing a method of producing a microstructure on a substrate, the method comprising:
(a) providing a substrate with a microstructure-forming preparation, said preparation being according to the invention;
(b) exposing one or more predetermined areas thereof to light of said one or more first wavelengths; and
(c) developing said one or more exposed areas, non-exposed areas, or both, of the preparation.

Generally, the predetermined areas of exposure can be selected by any suitable means for defining an illumination pattern, such as a mask blocking off regions which are not to be illuminated. However, a narrow laser beam, or an electron beam, can be controlled to obtain a similar effect, in particular in producing patterns of small dimensions and with high resolution.

In a preferred embodiment, said microstructure-forming preparation is exposed through a mask.

Masks are produced according to methods known in the art, see e.g. S. M. Sze, “Semiconductor Devices—Physics and Technology”, Wiley and Sons (1985).

A Microstructure Obtainable by the Method

In still another aspect, the present invention fulfils these objects by providing a microstructure, said microstructure being obtainable by the method according to the invention.

Specifically, a preferred embodiment for applications in micro flow systems, the microstructure is in form of a micro channel.

The microstructure can be in any suitable form, e.g. as a structured layer on a substrate. However, other forms are possible such as sheets or foils which can be transferred to desired substrates and fixed thereto.

In a preferred embodiment, the microstructure is in form of a microstructured sheet or foil.

A Method of Joining a Workpiece and a Microstructure

In still another aspect, the present invention fulfils these objects by providing a method of joining a workpiece and a microstructure, the method comprising:
(a) providing a substrate;
(b) providing a microstructure on said substrate, said microstructure being according to the invention;
(c) applying the workpiece onto said microstructure;
(d) compressing said substrate, microstructure and workpiece;
(e) exposing said compressed microstructure to light of said one or more second wavelengths, said exposure providing heat to said applied workpiece to increase its temperature above its softening point, said softened workpiece being pressed against said microstructure during said exposure; and
(f) cooling said softened workpiece during said compression.

In a preferred embodiment, said microstructure is provided by exposing a structure-forming preparation according to the invention by a method according to the invention.

Generally, the substrate can be any substrate having a surface to which the structure-forming preparation can be fixed. The substrate surface can be treated to promote such fixation, e.g. surfaces of silicon wafers can be activated by e.g. plasma treatment or any other suitable means. Also, polymer surfaces can be activated by plasma treatment.

In a preferred embodiment, said substrate is selected from the group of materials comprising silicon, glass, ceramics, metals, and polymers, preferably thermo plastics, or such materials having activated surfaces.

In a preferred embodiment, said substrate is structured, e.g. the substrate is in form of a structured silicon wafer or a micro chip.

Generally the workpiece applied to the microstructure is any suitable cover means, e.g. a component, plate, or laminate in any suitable material.

In a preferred embodiment, the workpiece is selected from the group comprising polymers, preferably thermo plastics.

Generally, at least either one of the substrate or the workpiece is transparent to the light of the one or more light-absorbing substances so that light can be transmitted and absorbed by said light-absorbing substances.

A Micro Channel Structure and Use Thereof

In still another aspect, the present invention fulfils these objects by providing a microstructure obtainable by the method according to the invention, the microstructure comprising a workpiece joined thereto, e.g. in form of a micro channel structure.

In still another aspect, the present invention fulfils these objects by providing use of such a microstructure in lab-on-chip applications, in point-of care systems, in high-through-put screening systems, preferably such systems for screening active compounds in fluids, preferably biological fluids.

### 3. BRIEF DESCRIPTION OF THE DRAWINGS

In the following, by way of examples only, the invention is further disclosed with detailed description of preferred embodiments. Reference is made to the drawings in which

FIGS. 1A-1D illustrate a sequence of process steps in production of microstructure on a substrate;

FIGS. 2A-1D illustrate another sequence of process steps in production of microstructure on a substrate;

FIGS. 3A-1D illustrate another sequence of process steps in production of microstructure on a substrate;

FIGS. 4A-4D illustrate a sequence of process steps in joining a workpiece and a microstructure on a substrate;

FIGS. 5A-5D illustrate another sequence of process steps in joining a workpiece and a microstructure on a substrate;

FIGS. 6A-6D illustrate another sequence of process steps in joining a workpiece and a microstructure on a substrate; and

FIGS. 7A-7D illustrate another sequence of process steps in joining a workpiece and a microstructure on a substrate.

### 4. DETAILED DESCRIPTION

Preparation of a Microstructure-Forming Preparation, IR-Dyed EPON SU-8

A microstructure-forming preparation was prepared by dissolving and/or admixing 100 milligram IR-dye powder, here Epolight™ 2057 supplied by Epolin, Inc., in 50 ml photoresist, here EPON SU-8™ 25 supplied by MicroChem, Inc., other SU-8 formulations can be used, e.g. of different viscosities SU-8 5, SU-8 10, SU-8 50, SU-8 100, in a beaker using a magnetic stirrer for 10 hours at 25° C. The resulting liquid had a dark green appearance, and maintained its relevant properties for micro lithography, e.g. its viscosity, UV-light transmission, etc.

The microstructure-forming preparation was stored in a syringe with its orifice pointing downwards to allow bubbles to move away from the orifice.

Preparation of a Microstructure on a Substrate, Here a Silicon/Glass Wafer with Structured IR-Dyed EPON SU-8

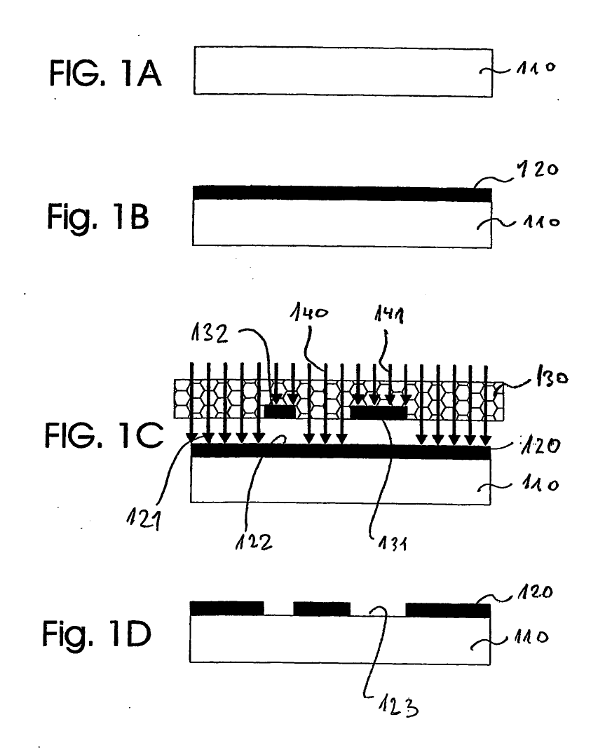

FIGS. 1A-1D illustrate a sequence of process steps in production of a microstructure on a substrate.

A microstructure-forming preparation, here a preparation as described above is applied to a surface of a substrate 110, here a silicon wafer surface which has been pretreated, dried, and cooled to room temperature as described below. In the present embodiment, spin coating is applied.

After cooling of the substrate to room temperature, the substrate is placed in a spin coater, preferably immediately after said cooling of the pre-treated substrate whereby the risk of contamination can be reduced. The substrate is fixed in the spin coater. About 4 ml of the structure-forming preparation, here EPON SU-8 with admixed IR-dye as described above, is dispensed at the centre of the substrate.

The substrate is spun with an acceleration of about 100 rpm/s to a spin rate of about 500 rpm at which spin rate it is maintained for about 5 seconds in order for the structure-forming preparation to cover the entire substrate. The substrate is further spun with an acceleration at about 300 rpm/s to a spin rate of about 1850 rpm and held for about 30 seconds whereby the thickness of the structure-forming preparation is 25 micrometer. The desired thickness can be controlled in the range 5-75 micrometer, by adjusting the spin rate during the spin cycle.

The spun structure-forming preparation on the substrate is consolidated by a consolidation treatment, here a temperature treatment comprising soft baking. In an embodiment, the substrate with structure-forming preparation is subjected to drying and heat treatment comprising increasing the treatment temperature according to a predetermined temperature profile. Here, the substrate, e.g. a silicon wafer with IR-dyed EPON SU-8 spun on to it is transferred to a level hotplate and baked for about 15 minutes at about 95° C. to remove solvent from the IR-dyed EPON SU-8. The temperature is preferably increased at a rate sufficient to avoid stress and cracks in the consolidated structure-forming preparation. Here the hotplate temperature was increased at a rate of less than 5° C./min to avoid stress and cracks in the IR-dyed SU-8 layer. In the case that the structure-forming preparation is a liquid, it is handled to ensure that a uniform thickness is obtained. That is, e.g. before and during baking, the IR-dyed SU-8, which is a liquid, is levelled to ensure a uniform layer thickness. The dried, baked substrate with applied structure-forming preparation is illustrated in FIG. 1B.

The prepared substrate with structure-forming preparation is exposed to UV light at a wavelength of about 365 nm in a Suss MA6 mask-aligner/exposure apparatus. UV light is illuminated onto photo mask 130, here a photo mask with UV-absorbing/reflecting material 131,132. The photo mask defines a pattern of UV-light 140,141, and exposed 121 and unexposed 122 regions of said UV-light on the structure-forming preparation, said photo mask being positioned in a mask aligner for accurate adjustment of mask and exposure pattern, see FIG. 1C.

Exposure parameters of exposure times, source distance, are selected for the applied UV source, wavelength, etc., and the given structure-forming preparation to provide an exposure required for the microstructure.

As an example, an UV exposure of 850 mJ/cm², using an Hg lamp with an I-line (365 nm) filter, was used to expose 25 μm of IR-dyed SU-8.

Thicker layers require more illumination to provide a sufficient exposure. Furthermore, typically about 50% more exposure is necessary for a layer of about 25 μm IR-dyed SU-8 compared to a non-dyed SU-8 layer. Recommended exposure doses of non-dyed SU-8 layers are listed in the SU-8 datasheet supplied by Microchem, the manufacturer of SU-8.

The exposed structure-forming preparation with substrate is subjected to a post-exposure treatment for cross-linking the photo resist. Here the illuminated substrate is baked on a level hotplate to cross-link the exposed SU-8.

The temperature treatment for providing the required cross-linking is selected by experimental calibration. Here a temperature profile as described for the consolidation treatment by soft baking has been applied.

The post-exposure structure-forming preparation on the substrate is developed to form the final microstructure as shown in FIG. 1D. Procedures for developing the exposed structure-forming preparation generally follows procedures for development of photo resist materials. Such procedures are known to a skilled person, and usually recommended by the suppliers, including multi treatments with several developer preparations, depending on the application.

Here, the SU-8 layer is developed in a SU-8 developer PGMEA supplied by Microchem for 5 minutes. FIG. 1D shows the result of the development including e.g. an open channel 123 in the microstructure 120.

Subsequent treatment might be needed in order to remove all partially cross-linked photo resists. Here, partially cross-linked SU-8 residues are removed by rinsing in isopropanol for 5 minutes and drying in air.

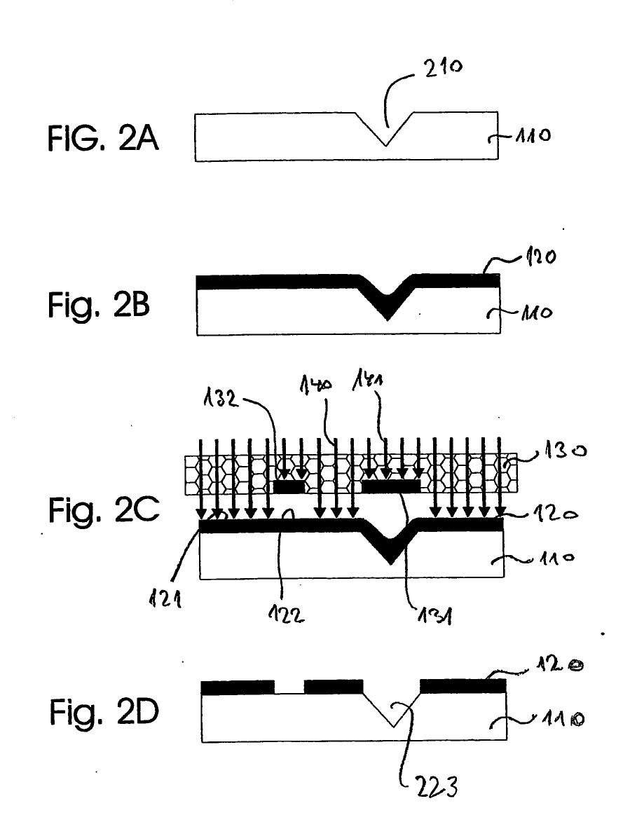

FIGS. 2A-2D illustrates another sequence of process steps in production of microstructure on a substrate wherein the substrate 110 has already been microstructured with a micro channel in its surface 210, see FIG. 2A. In the final structure the micro channel is redeveloped, see FIG. 2D.

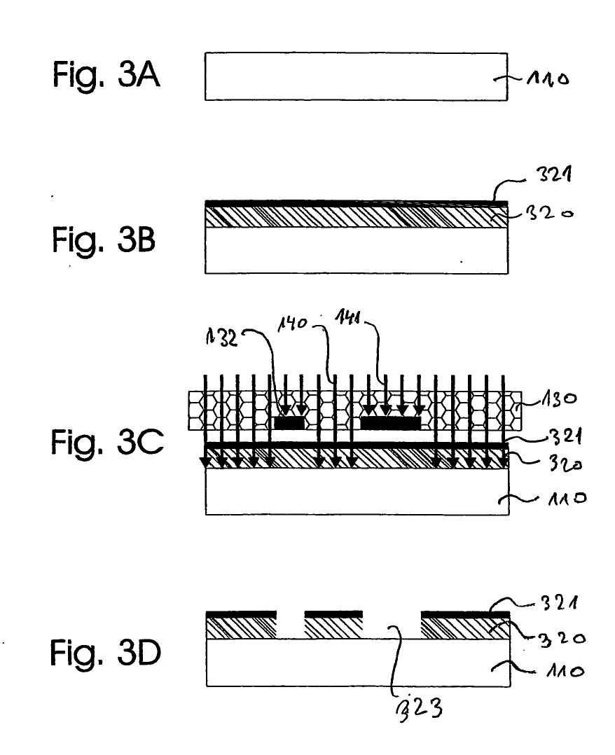

FIGS. 3A-3D illustrates still another sequence of process steps in production of microstructure on a substrate wherein the structure-forming preparation is applied as a two-layered structure. A first layer applied to a substrate 110 constitutes a basis layer 320, said basis layer comprising a relatively thick structure-forming layer, without light-absorbing substance, e.g. without IR-absorbing substance, and the second layer 321 applied to said first layer constitutes an adhesive structure-forming layer with added light-absorbing substance, said second layer often being much thinner than the first layer. The final structure comprises a micro channel 323, see FIG. 3D.

Joining a Workpiece and a Microstructure on a Substrate, Here a Silicon/Glass Wafer

The processed wafer is diced or sawed into chips that individually are joined to workpieces, e.g. joined to polymer components and/or polymer plates.

In an application of the prepared microstructure with substrate, micro flow channels are prepared in the microstructure, e.g. for use in a micro flow device.

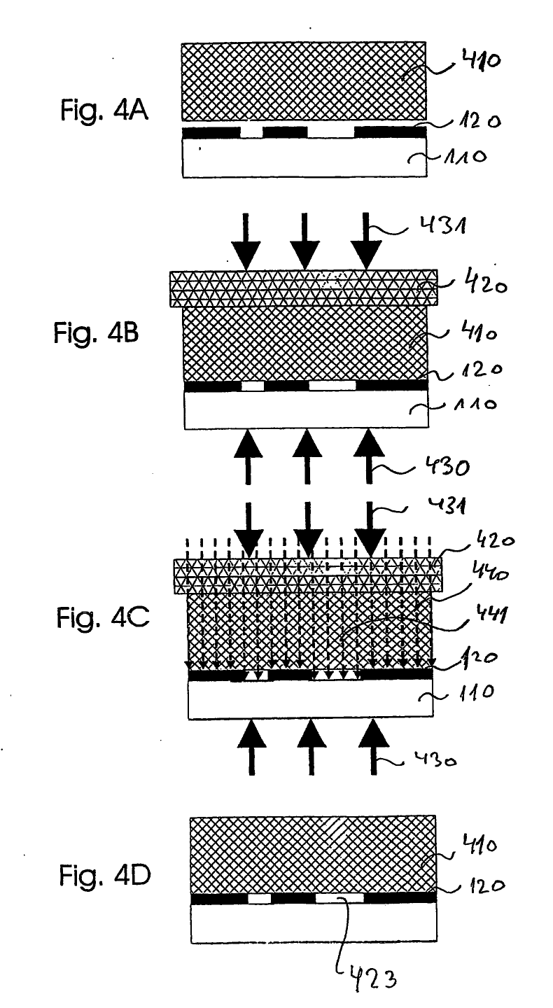

Generally, micro flow channels are prepared by enclosing open channels 123, 223, 323 in the microstructure 120, 320, 321, said microstructure comprising developed photo resist material which protrudes from the substrate and defines walls of an open channel. For closing the open channels, the respective protrusion parts of the microstructure of the open channel to be closed are covered by a cover means. Typically, the cover means comprises a lid or another closure-forming element. The cover means is then, simultaneously or subsequently, fixed to said protrusion parts of the micro channel forming closed channels 423, 523, 623, and 723, see FIGS. 4D, 5D, 6D, and 7D.

Generally, covering and fixing a cover means to form a micro channel can be obtained by joining a workpiece and a microstructure prepared according to the invention.

The following examples describe embodiments of the joining procedure, specifically joining a soft polystyrene-(PS)-polymer component, plate, or laminate to a silicon wafer/chip.

### 5. EXAMPLES

### Example 1

FIGS. 4A-4D illustrate a sequence of process steps for joining a workpiece and a microstructure on a substrate.

An IR transparent polymer component, plate, or laminate 410 of polystyrene is precisely placed on top of the silicon wafer/chip 110 with a microstructure. Compression forces 430,431, here corresponding to pressure about 4 hPa are applied to opposite sides of said substrate 110 and a transparent mask 420 on said polymer plate 410, and the two parts are pressed together.

The chip/polymer-plate assembly is exposed to light 440, 441, here a line scan of 1 mm×15 mm IR radiation at a scan rate of 35 mm/s from a 940 nm IR diode laser adjusted to a power level of 40 W, see FIG. 4C. The polymer plate is transparent to the IR radiation, but the photo resist is IR absorbing. IR light is absorbed and converted into heat which dissipates into the surface of the workpiece, here the polymer component or polymer plate. The produced heat and the temperature achieved are controlled by the exposure parameters. By heat conduction the IR-exposed microstructure, here the microstructured SU-8 photo resist, is heated and heat is conducted to the neighbouring materials, in particular heat is conducted into the polymer component/plate. By precisely controlling the exposure parameters, optionally based on calibration experiments for assessment of effective IR-dye concentrations and IR-illumination parameters, the first few micrometer of the polymer can be plasticized thus forming a thermo-adhesive bond with the photo resist, see FIG. 4C. Following cooling the final microstructure with flow channel 423 is formed. The IR-dyed SU-8 photo resist is thermally stable to at least 200° C. which is well above the glass transition temperature of many of the relevant materials for workpieces, e.g. of most polymers. In the IR-dyed SU-8 photo resist, the pattern forms a functional structure, such as micro channels. Fixing an IR transparent polymer component and/or plate thereon closes these micro channels.

The following 4 examples describe the joining procedure.

### Example 2

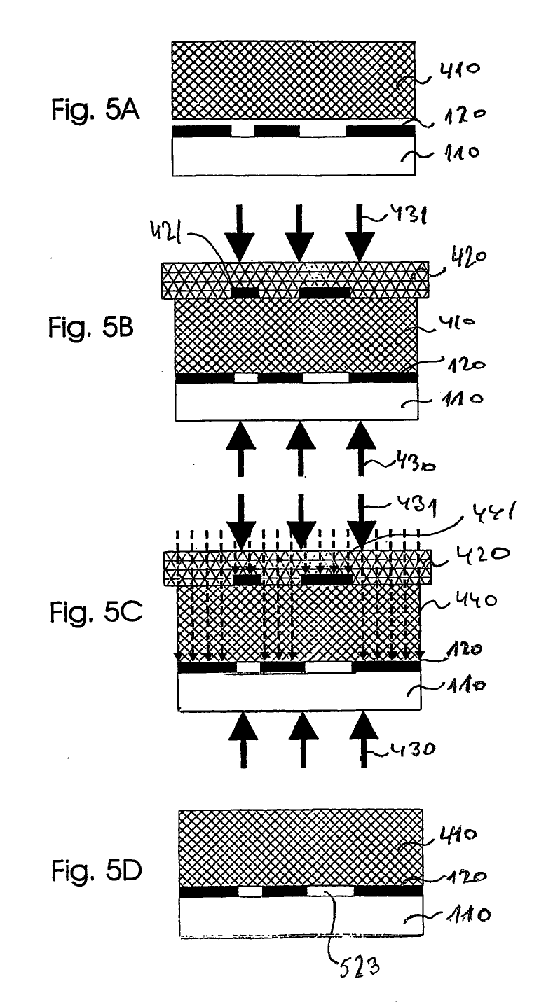

FIGS. 5A-5D illustrate another sequence of process steps in joining a workpiece and a microstructure on a substrate, producing a flow channel 523, see FIG. 5D.

This example is like example 1, except that the exposure to IR light is provided through a photo mask. The photo mask serves to prevent small amounts of molten polymer to enter the micro channels at the polymer/photo resist interface.

### Example 3

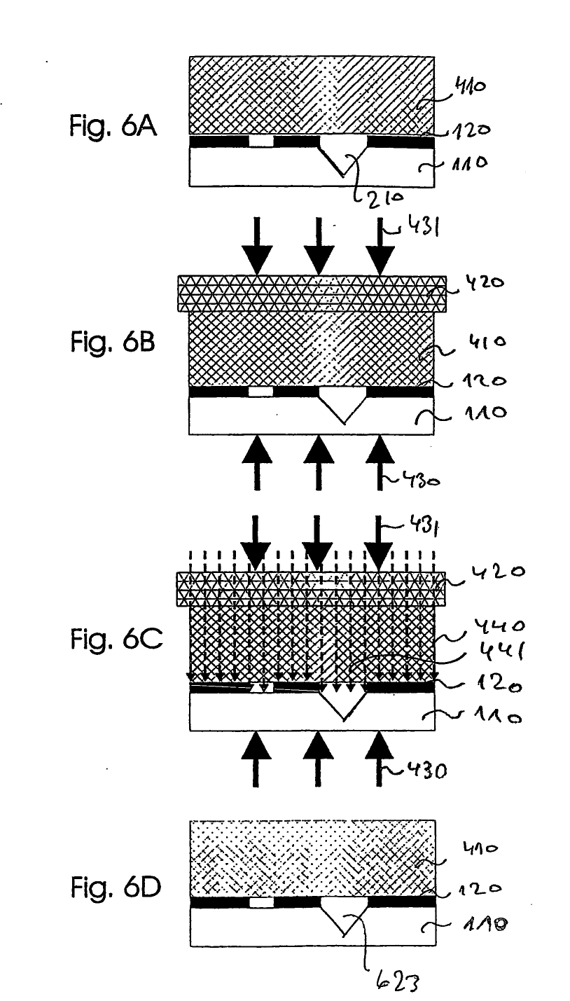

FIGS. 6A-6D illustrate another sequence of process steps in joining a workpiece and a microstructure on a substrate, producing a flow channel 623, see FIG. 6D.

This example is like examples 1 and 2, except that the silicon chip has been prestructured with an open micro channel 210 which is preserved in the final microstructure as a flow channel 230.

### Example 4

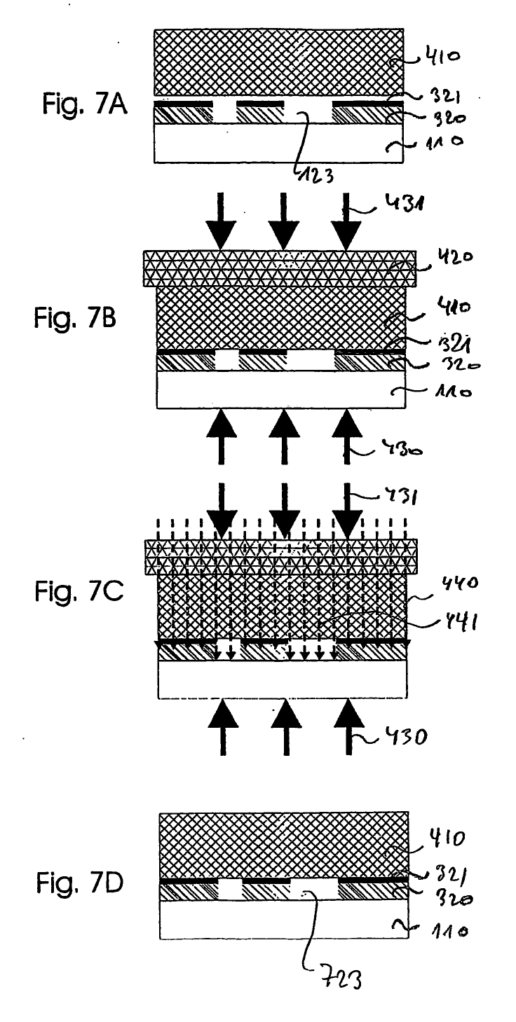

FIGS. 7A-7D illustrate still another sequence of process steps in joining a workpiece and a microstructure on a substrate, producing a flow channel 723, see FIG. 7D.

This example is like examples 1 and 2, except that the photo resist is applied in two steps. First a relatively thick layer of traditional SU-8 photo resist, without IR absorbing substance added, is spin coated on the silicon wafer/chip. Then, a relatively thin layer of photo resist with IR absorbing substance added is spin coated on the first layer.

This approach produces UV-defined microstructures in the photo resist, which have not been influenced by the IR-absorbing dye, said dye both absorbing and scattering UV radiation. Consequently, a possible influence of the IR-absorbing substance can be avoided or reduced thereby decreasing distortion of the microstructure in photo imaging process. A thinner absorbing layer reduces such interferences of the light-sensitive, structure-forming material used for microstructuring.

A further advantage of this method is that it ensures that IR absorption and thus heating only occur at the silicon/polymer interface. Heating at the silicon/photo resist interface is reduced whereby thermal stress of the silicon/photo resist interface can be avoided or reduced.

1. A microstructure-forming composition, the composition comprising:
i) a light-sensitive, structure-forming material, said material comprising one or more photo resist materials which are sensitive to light of one or more first wavelengths; said photo resist materials being structurable by exposure to light of said one or more first wavelengths and subsequent chemical development, and
ii) a light-absorbing material, said material comprising one or more light-absorbing substances absorbing light at one or more second wavelengths, said one or more second wavelengths being different from said one or more first wavelengths of said photo resist materials, and said one or more light-absorbing substances being in an amount sufficient to produce heat upon exposure to said one or more second wavelengths.

2. The composition according to claim 1 wherein said one or more photo resist materials are sensitive to UV light at said one or more first wavelengths.

3. The composition according to claim 2 wherein said light of said one or more first wavelengths has a wavelength the range 190 to 450 nm, preferably 300 to 400 nm.

4. The composition according to claim 1 wherein said one or more photo resist materials comprise a phenoxy polyol resin formed as the condensation product of epichlorohydrin and a bisphenol A, preferably an epoxidized multifunctional bisphenol A formaldehyde novolac resin, in particular an octafunctional bisphenol.

5. The composition according to claim 1 wherein said light-sensitivity and structure-forming material further comprises a photo initiator.

6. The composition according to claim 5 wherein said photo initiator is a cationic photo initiator, preferably a triarysulfonium hexafluoroantimonate salt.

7. The composition according to claim 1 wherein said one or more light-absorbing substances is an IR absorbing material or a mixture of IR absorbing materials.

8. The composition according to claim 1 wherein said light of said one or more second wavelengths has a wavelength in the range of 700 nm to 15 μm, preferably of 780 to 1700 nm, most preferably of 800 to 1000 nm.

9. The composition according to claim 1 wherein said light of said one or more light-absorbing substances are present in an effective amount to absorb light energy for producing a predetermined amount of heat.

10. The composition according to claim 1 wherein said light of said one or more light-absorbing substances are selected from the groups comprising: cyanine, squarylium, and croconium.

11. The composition according to claim 1 wherein said light of said one or more photo resist materials upon exposure to said light of one or more first wavelengths are developed as a positive photo resist, a negative photo resist, or a combination thereof.

12. A microstructure-forming preparation, the preparation comprising a composition as defined in claim 1, and being in form of a liquid, a paste, a film, or a laminate.

13. The preparation according to claim 12 having an exposed surface wherein said one or more light-absorbing substances are in an amount sufficient to produce heat at said exposed surface upon exposure to light of said one or more second wavelengths, preferably a major portion of said amount of said one or more of light-absorbing substances being present in or near said exposed surface.

14. The preparation in form of a laminate according to claim 12 wherein said one or more light-absorbing substances are present in a top layer of said laminate.

15. A method of producing a microstructure on a substrate, the method comprising:
a) providing a substrate (110) with a microstructure-forming preparation (120), comprising a composition according to claim 1;
b) exposing one or more predetermined areas thereof to light (140) of said one or more first wavelengths; and
c) developing said one or more exposed areas, non-exposed areas (121), or both, of the preparation.

16. The method according to claim 15 wherein said microstructure-forming preparation is exposed through a mask (130, 131).

17. A microstructure obtainable by the method defined in claim 15.

18. The microstructure according to claim 17 in the form of a micro channel.

19. The microstructure according to claim 18 in the form of a microstructured sheet or foil.

20. A method of joining a workpiece and a microstructure, the method comprising:
a) providing a substrate;
b) providing a microstructure on said substrate;
c) applying the workpiece onto said microstructure;
d) compressing said substrate, microstructure and workpiece;
e) exposing said compressed microstructure to light of said one or more second wavelengths, said exposure providing heat to said applied workpiece to increase its temperature above its softening point, said softened workpiece being pressed against said microstructure during said exposure; and
f) cooling said softened workpiece during said compression.

21. The method according to claim 20 wherein said microstructure is provided by exposing a structure-forming preparation as defined in claim 12.

22. The method according to claim 20 wherein said substrate is selected from the group materials comprising silicon, glass, ceramics, metals, and polymers, preferably thermo plastics, or optimally such materials having activated surfaces.

23. The method according to claim 20 wherein said substrate is structured.

24. The method according to claim 20 wherein the workpiece is selected from the group comprising polymers, preferably thermo plastics.

25. A microstructure obtainable by the method defined in claim 20, the microstructure comprising a workpiece joined thereto.

26. A microstructure as defined in claim 25 for use n lab-on-chip applications, in point-of care systems, in high-throughput screening systems, preferably such systems for screening active compounds in fluids, preferably biological fluids.

27. A method of joining a workpiece and a microstructure, the method comprising:
A) providing a substrate (110);
B) providing a microstructure (12) on said substrate, said microstructure being produced by:
a) providing said substrate (110) with a microstructure-forming preparation (120), said preparation comprising a composition comprising:
i) a light-sensitive, structure-forming material, said material comprising one or more photo resist materials which are sensitive to light of one or more first wavelengths; said photo resist materials being structurable by exposure to light of said one or more first wavelengths and subsequent chemical development, and
ii) a light-absorbing material said material comprising one or more light-absorbing substances absorbing light at one or more second wavelengths, said one or more second wavelengths being different from said one or more first wavelengths of said photo resist materials, and said one or more light-absorbing substances being in an amount sufficient to produce heat upon exposure to said one or more second wavelengths, and being in form of a liquid, a paste, a film, or a laminate;
b) exposing one or more predetermined areas thereof to light (140, 141) of one or more first wavelengths; and
c) developing said one or more exposed areas (121), non-exposed areas (122), or both, of the preparation;
C) applying the workpiece (410) onto said microstructure;
D) compressing (430, 431) said substrate, microstructure and workpiece;
E) cooling said softened workpiece during said compression.

28. A microstructure obtainable by the method defined in claim 27, the microstructure comprising a workpiece joined thereto.
